(19) United States
(12) Patent Application Publication
(10) Pub. No.: US 2004/0251662 A1
(43) Pub. Date: Dec. 16, 2004

(54) Safety device for motor vehicles

(76) Inventors: Andree Burgstaler, Dielingen (DE); Jan Dutz, Damme (DE); Simone Papke, Osnabruck (DE)

Correspondence Address: McGlew & Tuttle, Scarborough Station, Scarborough, NY, 10510-0827, US

(21) Appl. No.: 10/481,229

(22) PCT Filed: Feb. 18, 2003
(86) PCT No.: PCT/DE03/00495

(30) Foreign Application Priority Data
Mar. 7, 2002 (DE) 102 09 907.3

(51) Int. Cl. B60R 21/22

(52) U.S. Cl. 280/730.1

(57) ABSTRACT

A safety device for a motor vehicle has features for performing a safety function that can become necessary especially in an accident. The safety device has at least one mounting part (4) with at least one hole (11). Furthermore, at least one bolt (2) is present, which is coaxially inserted into the hole (11) to connect the mounting part (4) with a connecting piece (1). A device for removing a mounting element or the bolt (2), especially a pedal bolt of the motor vehicle or for releasing the connecting piece (1) from the mounting part (4) in the form a mechanism (8) can be activated in an accident. The mechanism (8) is accommodated in a housing (6) connected to the mounting part (4) and is connected with the bolt (2) in the axial extension of the bolt axis (12).

### FIELD OF THE INVENTION

The present invention pertains to a safety device for a motor vehicle for performing a safety function, as can become necessary especially in an accident. The safety device has at least one mounting part with at least one hole. Furthermore, at least one bolt is present, which is coaxially inserted into this hole in order to connect the mounting part with a connecting piece. The bolt may pass completely through the hole or only a section of it may be accommodated therein. The safety device contains, furthermore, means for removing a mounting element or the bolt, especially a pedal bolt of the motor vehicle or for releasing the connecting piece from the mounting part.

### BACKGROUND OF THE INVENTION

Such safety devices are used, among other things, in the pedal mechanism in the leg room of passenger compartments of motor vehicles to prevent risks of injury because of direct collisions. The risks for injury are due to the fact that the occupants are unable to absorb the accelerating forces in a direct collision, so that, e.g., the lower extremities of the person sitting in the front area are thrown into the leg room. The entire leg room may undergo an extreme deformation in the above-mentioned accident situation. The injuries occurring as a consequence are painful for the person affected and may even lead to permanent mutilation. Various solutions have been known from the prior art to counteract this circumstance. Mainly two types of safety devices are distinguished. On the one hand, the pedal is prevented from moving in the direction of the interior space of the vehicle by bending or bending away a connecting piece, e.g., a push rod, and, on the other hand, the pedal is prevented from penetrating into the interior space of the vehicle by opening the mounting site of the pedal, which is caused by deformation, e.g., by the bending of structural parts, e.g., sheet metal parts.

Patent No. DE 100 40 043 discloses a safety device which prevents the pedal from penetrating into the leg room by opening the mounting site of the pedal. The safety device comprises a bearing block in which the pedals pivotable around an axis are mounted on bolts which are fixed in the mounts of the bearing block. The bearing block has at least one section that can be widened up, so that the force introduced from the outside during an accident leads to a deformation of the front firewall and consequently widens or spreads apart the bearing block. The widening may take place by means of a wedge-shaped element, which is driven between the legs of a bearing block. The kinetic energy needed for this is obtained from the movement of the motor vehicle parts that are undergoing a deformation in relation to one another during an accident. The bolts mounting the pedals are thus released, so that the pedals with the bolt are released from their brackets and do not penetrate into the leg room.

The drawback occurring in the case of the prior-art safety devices is that the mounting site of the pedal is opened only passively because of the deformation caused by a direct collision and the safety device is therefore dependent on the type and the intensity of the accident and is consequently unreliable. Moreover, the prior-art systems are isolated from other safety devices present in a motor vehicle, e.g., an air bag system, and therefore fail to offer a comprehensive protection.

### SUMMARY OF THE INVENTION

The object of the present invention is therefore to provide a safety device in which the opening of the mounting site and, more precisely, the removal of the bearing bolt from the mount is more reliable and independent from the type and the intensity of the accident, and coupling with other safety systems is also guaranteed at the same time.

According to the present invention a safety device is provided for removing a bolt, especially a pedal bolt, in a motor vehicle, with at least one first mounting part, which has at least one hole for a bolt connection with at least one connecting piece, as well as with at least one bolt, which is inserted coaxially into the said hole in order to connect the mounting part and the connecting piece with one another. Means are provided for removing the bolt or releasing the connecting piece to achieve a safety function. The means is designed as a mechanism that is accommodated in a housing connected with the mounting part and is connected with the bolt in the axial extension to the bolt axis. These means can be activated in case of an accident.

This solution offers the advantage that due to the active as well as passive triggering of the securing mechanism, the safety function of the device is independent of the type and the intensity of the deformation caused by a direct collision, without the current possibilities being limited. Furthermore, the safety device can now be coupled with other active safety devices, e.g., with an air bag triggering mechanism or a seat belt, in order to thus offer a more complete and more comprehensive protection. Moreover, the triggering no longer depends on the type of the direct collision, but any type of accident that requires a safety function is taken into account. No needless risks for injury nor limitations due to projecting components arise due to the compact design of the device according to the present invention.

The connecting piece may preferably be a pedal located in a passenger compartment of a motor vehicle, wherein a U-shaped bearing block may be used as the mounting part, and the assembly effort can thus be reduced in the case of a two-sided mount.

The bolt advantageously has a two-part design in order to make it possible to install two smaller safety devices, which can be arranged in a space-saving manner on both sides of the bolt and thus imply a low risk for injury, instead of a large safety device arranged on the bolt on one side.

The mechanism of the safety device may advantageously comprise a spring-loaded unit or a pyrotechnic unit or a combination of these units. Due to a securing mechanism that can be triggered actively or passively, the mechanism can be triggered both by a deformation and by active actuation as well as by a combination of the two, as a result of which a markedly better safety function can be achieved. Moreover, the spring-loaded unit is reusable due to a simple tensioning operation. Moreover, the spring-loaded unit represents an inexpensive solution for triggering the safety device.

Another advantage can be seen in that the mechanism is made of a pyrotechnic unit with a gas generator and of a securing mechanism that can be triggered actively or passively, because an inexpensive mechanism that can be manufactured with little effort is provided, which is easy to install and can be triggered excellently by means of an active sensor-actuator combination as well as passively by deformation.

Provisions are made in another measure improving the present invention for the means for removing the bolt to be arranged on one side of the bolt end each in the case of a two-part bolt, because a space-saving, compact mechanism can thus be arranged on the side of the mount. Moreover, it is guaranteed by the two-part design that the second mechanism will still ensure the triggering of the safety function should one mechanism fail.

It is particularly advantageous that the securing mechanism that can be actively triggered is a securing mechanism triggered by a sensor-actuator combination, because an electrical coupling with existing safety devices, e.g., an air bag triggering system of a motor vehicle, is thus possible.

The securing mechanism that can be triggered passively is preferably a lever, which is connected on one side with a bearing bolt to trigger the securing mechanism during a displacement of the mounting part, because the triggering, which depends on the deformation caused by a direct collision, can thus be set very well by means of the lever arm.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a cross sectional schematic view of a first safety device according to the present invention for removing a bolt; and

FIG. 2 is a cross sectional schematic view of a safety device according to the present invention for removing a bolt in another embodiment.

### DESCRIPTION OF THE PREFERRED EMBODIMENT

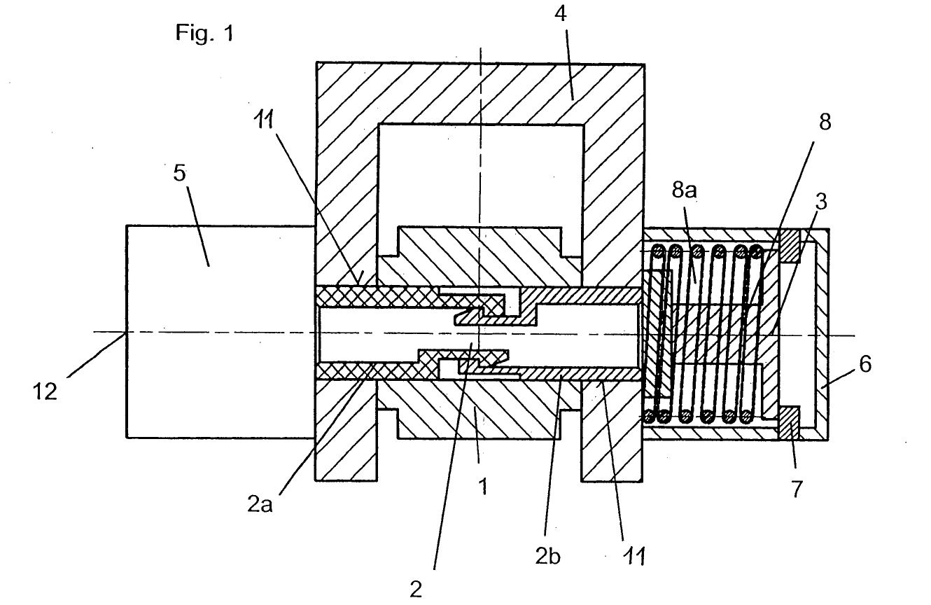

Referring to the drawings in particular, the safety device according to FIG. 1 comprises a connecting piece 1, which is designed as a pedal and which is connected to a mounting part 4 via a bolt 2. The U-shaped mounting part 4 designed as a one-part bearing block has different mechanisms 8 on both sides in the view. A mechanism in the form of a pyrotechnic unit 5 is fastened on the left-hand side and a mechanism 8 designed as a spring-loaded unit is fastened on the right-hand side.

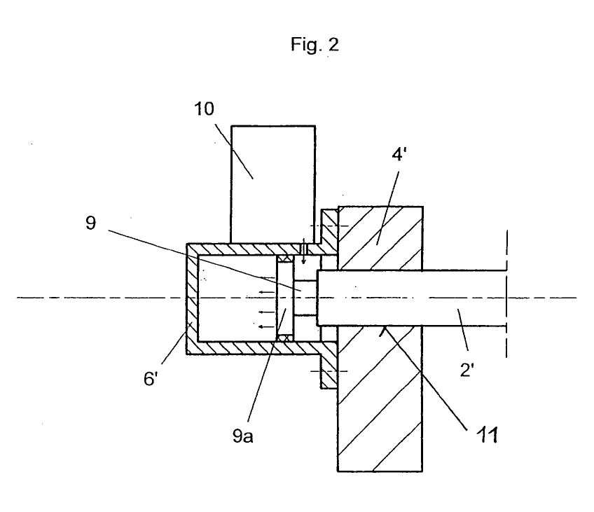

The bolt 2 comprises two bolt halves 2a and 2b, which are connected to one another in a positive-locking or non-positive manner. In conjunction with a mechanism 8 designed as a spring-loaded unit, one bolt half 2b is equipped or connected with a spring plate 3. The entire mechanism 8 consequently comprises a spring plate 3, a compression spring 8a and a securing mechanism 7, which is surrounded by a closed housing 6. Before the right-hand bolt half 2b is inserted into the mounting part 4, the compression spring 8a is pushed over the bolt half 2b. When the bolt half 2b is inserted into the mounting part 4, the compression spring 8a is tensioned. To prevent the bolt 2 from being pulled out of the mounting part 4 due to the strong spring force of the compression spring 8a, a securing mechanism 7 is used, which locks the spring plate 3 connected to the bolt 2 in the pretensioned position. The entire mechanism 8 is surrounded by a closed housing 6, which is adapted to the mechanism 8 such that it guarantees the guiding of the mechanism 8 designed as a spring-loaded unit and can accommodate the securing mechanism (not shown). The securing mechanism 7 is released during the active or passive triggering of the safety function, and the compression spring 8a pulls the right-hand half of the two-part bolt 2b, which is separated from the left-hand bolt half 2a because of the strong spring force, out of the mounting part 4. The left-hand bolt half 2a is pulled out correspondingly on the left-hand side of the mounting part 4′ either by an analogous mechanism 8 located mirror-symmetrically to the radial cross section of the bolt 2 or by a mechanism which is schematically shown in FIG. 2 and will be described in greater detail below.

A mechanism designed as a pyrotechnic unit, which is shown on the left-hand side of FIG. 1, is schematically shown in FIG. 2. A bolt 2′ is connected here on one side with a piston 9a and thus forms a piston-and-bolt system 9. The piston-and-bolt system 9 accommodates a housing 6′, which guarantees, among other things, the guiding of the piston 9a and makes possible the connection of a gas generator 10. When the safety function is triggered (not shown), the gas generator 10 generates an overpressure in a small cavity between the piston 9a and the bolt 2′ within the housing 6′, and this overpressure moves the piston 9a away from the mounting part 4′ and thus removes the bolt 2′ from the mounting part 4′.

While specific embodiments of the invention have been shown and described in detail to illustrate the application of the principles of the invention, it will be understood that the invention may be embodied otherwise without departing from such principles.

1-10. (Canceled).

11. A safety device for a motor vehicle for performing a safety function, the safety device comprising:
a mounting part with at least one hole;
a bolt inserted coaxially into said hole to connect said mounting part with a connecting piece;
removal means for removing a mounting element or a bolt or for releasing said connecting piece from said mounting part, said removal means including a housing connected to said mounting part and a mechanism which can be activated in an accident, said mechanism being accommodated in said housing and being connected with said bolt in the axial extension of said bolt axis.

12. A safety device in accordance with claim 11, wherein said connecting piece is a pedal located in a passenger compartment of a motor vehicle, wherein said mounting part is a bearing block mounting said pedal.

13. A safety device in accordance with claim 12, said bearing block is U-shaped.

14. A safety device in accordance with claim 11, wherein said bolt is a two-part bolt.

15. A safety device in accordance with claim 11, wherein said mechanism has a spring-loaded unit.

16. A safety device in accordance with claim 15, wherein said mechanism has a securing mechanism that can be released actively or passively.

17. A safety device in accordance with claim 11, wherein said mechanism has a pyrotechnic unit with a gas generator.

18. A safety device in accordance with claim 17, wherein said mechanism has a securing mechanism that can be released actively or passively.

19. A safety device in accordance with claim 14, wherein said means for removing said bolt includes a unit arranged on each side of the end of the bolt in the case of said two-part bolt.

20. A safety device in accordance with claim 15, further comprising a sensor-actuator combination wherein said securing mechanism that can be released actively is a securing mechanism triggered by said sensor-actuator combination.

21. A safety device in accordance with claim 17, further comprising a sensor-actuator combination wherein said securing mechanism that can be released actively is a securing mechanism triggered by said sensor-actuator combination.

22. A safety device in accordance with claim 16, wherein said securing mechanism that can be released passively is a lever, which is connected on one side with said bearing bolt to trigger the securing mechanism during the displacement of said mounting part.

23. A safety device in accordance with claim 18, wherein said securing mechanism that can be released passively is a lever, which is connected on one side with said bearing bolt to trigger the securing mechanism during the displacement of said mounting part.

24. A motor vehicle safety system, comprising:
a mounting part with at least one hole;
a connecting piece;
a bolt inserted coaxially into said hole connecting said mounting part with said connecting piece;
a housing connected to said mounting part;
a removal mechanism activated in an accident, said mechanism being accommodated in said housing and being connected with said bolt in the axial extension of said bolt axis for acting on said bolt to remove said bolt from a position connecting said mounting part to said connecting part.

25. A safety device in accordance with claim 24, wherein said connecting piece is a pedal located in a passenger compartment of a motor vehicle, wherein said mounting part is a bearing block mounting said pedal.

26. A safety system in accordance with claim 25, said bearing block is U-shaped and said bolt is a two-part bolt.

27. A safety system in accordance with claim 11, wherein said mechanism has one of a spring-loaded unit and pyrotechnic unit with a gas generator.

28. A safety system in accordance with claim 27, wherein said mechanism has a securing mechanism that can be released actively or passively.

29. A safety system in accordance with claim 16, wherein said means for removing said bolt includes a unit arranged on each side of the end of the bolt in the case of said two-part bolt.

30. A motor vehicle safety system, comprising:
a bearing block with at least one hole;
a pedal with at least on through hole;
a bolt inserted coaxially into said bearing block hole and through said through hole and connecting said mounting part with said connecting piece;
a housing connected to said mounting part;
a removal mechanism activated in an accident, said mechanism being accommodated in said housing and being connected with said bolt in the axial extension of said bolt axis for acting on said bolt to remove said bolt from a position connecting said mounting part to said connecting part.
